(19) United States
(12) Patent Application Publication
(10) Pub. No.: US 2025/0173993 A1
(43) Pub. Date: May 29, 2025

(54) SYSTEM AND METHOD FOR REAL TIME OPTICAL ILLUSION PHOTOGRAPHY

(71) Applicant: Samsung Electronics Co., Ltd., Suwon-si (KR)

(72) Inventors: Aman KUMAR, Delhi (IN); Vikash Kumar SAH, Delhi (IN); Ashish CHOPRA, Uttar Pradesh (IN)

(21) Appl. No.: 19/036,636

(22) Filed: Jan. 24, 2025

Related U.S. Application Data
(63) Continuation of application No. PCT/KR2023/007893, filed on Jun. 8, 2023.

(30) Foreign Application Priority Data
Jul. 27, 2022 (IN) 202241043111

(51) Int. Cl. G06V 10/26; G06T 11/60; G06V 10/25; G06V 10/764; G06V 10/77; G06V 10/82

(52) U.S. Cl. CPC G06V 10/267; G06T 11/60; G06V 10/25; G06V 10/764; G06V 10/7715; G06V 10/82

(57) ABSTRACT

The disclosure provides a system and method for real time optical illusion photography. The method may include: receiving an input image, detecting one or more objects of interest in the input image, dissociating a foreground region and a background region from the input image, extracting a plurality of features extracted from the foreground and the background region of the image in three-dimensional format, generating a three-dimensional feature map, predicting the plurality of features from the feature map of the image, classifying the predicted plurality of features into one or more illusions which are applicable on the input image based on prediction table, determining at least one foremost illusion, out of all possible applicable illusions, and applying real time illusion effects on the input image based on the determined foremost illusion.

### CROSS-REFERENCE TO RELATED APPLICATIONS

This application is a continuation of International Application No. PCT/KR2023/007893 designating the United States, filed on Jun. 8, 2023, in the Korean Intellectual Property Receiving Office and claiming priority to Indian Patent Application No. 202241043111, filed on Jul. 27, 2022, in the Indian Patent Office, the disclosures of each of which are incorporated by reference herein in their entireties.

### BACKGROUND

### Field

The disclosure relates a system and method for real time optical illusion photography. The disclosure relates to the method of predicting and applying the most prominent real time illusion effects on the image.

### Description of Related Art

Optical illusion photography is a photographic representation of a visible object or phenomenon that does not correspond to reality, e.g., optical illusion of sight. Visual illusions are perceptions that deviate from what is generally predicted based on the physical stimulus. Visual illusions reflect the limitations that the visual system has evolved to support in order to facilitate the effective construction of visual representations that are also adequate for representing our external environment.

Currently, users are familiar with the basic image editing functions such as cropping, resizing, enhancing, and adding effects to their images. These image editing features work on the image as a whole and enhances the images, but there is no method available to create illusions with the help of individual objects present in the image. To achieve such illusions, a user must rely on a combination of manual tools and much more complicated image editing software solutions such as Photoshop to re-edit their images. However, one of the biggest challenges is to re-edit the images using these image editing tools according to the need because as these tools require prior knowledge to use.

Various attempts have been made to create illusion effects. The drawback of current devices and methods for creating illusions resides in the limitations associated with the real object. However, real objects tend to be motionless and thus produce very unimaginative real images.

For instance, US Patent Application No. US20170148222A1 titled “Real-time mobile device capture and generation of art-styled AR/VR content” discloses systems and processes for generating AR/VR content, wherein for generating a 3D projection of an object in a virtual reality or augmented reality environment comprises obtaining a sequence of images along a camera translation using a single lens camera. Each image contains a portion of overlapping subject matter, including the object. The object is segmented from the sequence of images using a trained segmenting neural network to form a sequence of segmented object images, to which an art-style transfer is applied using a trained transfer neural network. However, “US20170148222A1” merely discloses the method of generating 3D projection in virtual reality or augmented reality environment using a single lens mobile phone camera and does not disclose details pertaining to creating optical illusion effect using image processing techniques.

For instance, US patent Application No. U.S. Pat. No. 9,741,125B2 titled “Method and system of background-foreground segmentation for image processing” discloses method of background-foreground segmentation for image processing, obtaining pixel data including both non-depth data and depth data for at least one image, wherein the non-depth data includes color data or luminance data or both and associated with the pixels, determining whether a portion of the image is part of a background or foreground of the image based on the depth data and without using the non-depth data, and determining whether a border area between the background and foreground formed using the depth data are part of the background or foreground depending on the non-depth data without using the depth data. However, “U.S. Pat. No. 9,741,125B2” merely discloses the analysis of the image to identify objects, determine attributes of the objects and separating out foreground and background and does not disclose details pertaining to creating optical illusion effect using image processing techniques.

For instance, US patent Application No. U.S. Pat. No. 8,861,836B2 tiled “Methods and systems for 2D to 3D conversion from a portrait image” discloses a method for converting a 2D image into a 3D image, receiving the 2D image; determining whether the received 2D image is a portrait, wherein the portrait can be a face portrait or a non-face portrait; if the received 2D image is determined to be a portrait, creating a disparity between a left eye image and a right eye image based on a local gradient and a spatial location; generating the 3D image based on the created diparity, and outputting the generated 3D image. However, “U.S. Pat. No. 8,861,836B2” simply discloses the method to determine whether the 2D image is close-up image or not and within the close-up whether it is face portrait or a non-face close-up image, segmenting foreground cells containing a foreground object from background cells in the plurality of cells, and generating the 3D image computationally based on the disparity created by horizontal gradient and a face depth map and does not disclose details pertaining to creating optical illusion effect using image processing techniques.

Therefore, there is a need for a system that enables users to automatically create various illusion effects in images without the usage of manual tools or extremely complex photo-editing applications.

### SUMMARY

Embodiments of the disclosure address the drawbacks of the prior art by disclosing a system and method for real time optical illusion photography.

According to an example embodiment, there is provided a method for real time optical illusion photography. The method may include: receiving an input image; detecting one or more objects of interest in the input image; dissociating a foreground region and a background region from the input image; extracting a plurality of features from the foreground and the background region of the image in three-dimensional format; generating a three-dimensional feature map; predicting the plurality of features from the feature map of the image; classifying the predicted plurality of features into one or more illusions, applicable on the input image based on prediction table; determining at least one foremost illusion, out of all the possible applicable illusions; and applying real time illusion effects on the input image based on the determined foremost illusion.

According to an example embodiment, there is provided a system for real time optical illusion photography. The system may include: an image capturing device including circuitry configured to capture an input image, wherein one or more objects of interest are detected in the input image by an instance segmentation module comprising various circuitry; a dissociation network including an encoder-decoder architecture configured to dissociate a foreground region and a background region from the input image; a convolutional feature extraction module comprising various circuitry configured to extract a plurality of features from the foreground and the background region of the image in three-dimensional format; a detector network, a differential sampler and a descriptor network of the convolutional feature extraction module configured to generate a three-dimensional feature map; a feature prediction algorithm configured to predict the plurality of features from the feature map of the image and a decision network for classifying the predicted plurality of features into one or more illusions, applicable on the input image based on prediction table; an illusion selection network configured to determine at least one foremost illusion, out of all the possible applicable illusions, wherein real time illusion effects are configured to be applied on the input image based on the determined foremost illusion.

According to an example embodiment, there is provided a non-transitory computer-readable storage medium storing a program executable by a computer to execute the method for real time optical illusion photography.

### BRIEF DESCRIPTION OF THE DRAWINGS

The above and other aspects, features and advantages of certain embodiments of the present disclosure will be more more apparent from the following detailed description, taken in conjunction with the accompanying drawings, in which like reference numerals refer to like elements, and in which:

FIG. 1 is a flowchart illustrating an example method for real time optical illusion photography according to various embodiments;

FIG. 2 is a block diagram illustrating an example configuration of a system for real time optical illusion photography according to various embodiments;

FIG. 3 is a diagram illustrating an example of the process of image segmentation according to various embodiments;

FIG. 4 is a block diagram illustrating example operations involved in dissociation of the foreground and the background region of the image according to various embodiments;

FIG. 5 is a flowchart illustrating an example method of dissociating the foreground region and the background region from the input image according to various embodiments;

FIG. 6 is a diagram illustrating an example encoder-decoder architecture of the dissociation network according to various embodiments;

FIG. 7 is a diagram illustrating an example network architecture for illusion selection network according to various embodiments;

FIG. 8 is a block diagram illustrating example foreground and background region interpretation according to various embodiments;

FIG. 9 is a diagram illustrating an example output array of the decision network according to various embodiments;

FIG. 10 is a diagram illustrating a first example method for real time optical illusion photography according to various embodiments;

FIG. 11 is a diagram illustrating a second example method for real time optical illusion photography according to various embodiments;

FIG. 12 is a diagram illustrating an example method for real time optical illusion photography according to various embodiments;

FIG. 13 is a diagram illustrating an example method of obtaining candid photography according to various embodiments;

FIG. 14 is a diagram illustrating an example method of obtaining cinematic styling according to various embodiments;

FIG. 15 is a diagram illustrating an example Generative Adversarial Network (GAN) based architecture according to various embodiments;

FIG. 16 is diagram illustrating a first example image of a method of foreground repositioning according to various embodiments;

FIG. 17 is a diagram illustrating a second example image of a method of foreground repositioning according to various embodiments;

FIG. 18 is a diagram illustrating an example network architecture for creating real time illusion effect on a flat image according to various embodiments; and

FIG. 19 is a diagram illustrating example processing of subject alignment according to various embodiments.

### DETAILED DESCRIPTION

The disclosure will now be made in greater detail with reference to one or more examples with reference to the drawings. Each example is provided to explain the subject matter and is not a limitation. Various changes and modifications will be apparent to one skilled in the art to which the disclosure pertains and are deemed to be within the spirit, scope and contemplation of the disclosure.

Optical illusions, more appropriately known as visual illusions, involve visual deception. Due to the arrangement of images, the effect of colors, the impact of the light source, or other variables, a wide range of misleading visual effects can be seen. An optical illusion is caused by the visual system and characterized by a visual percept that appears to differ from reality. Illusions may include, for example, three types: physical class, physiological class, and cognitive class, and further every class may have four types: Ambiguities, distortions, paradoxes, and fictions are all examples of ambiguities. Optical illusion photography is an impression of a visible object or phenomenon that is not appropriate to reality, e.g., optical illusion of sight. The disclosure provides a method and system for real time optical illusion photography.

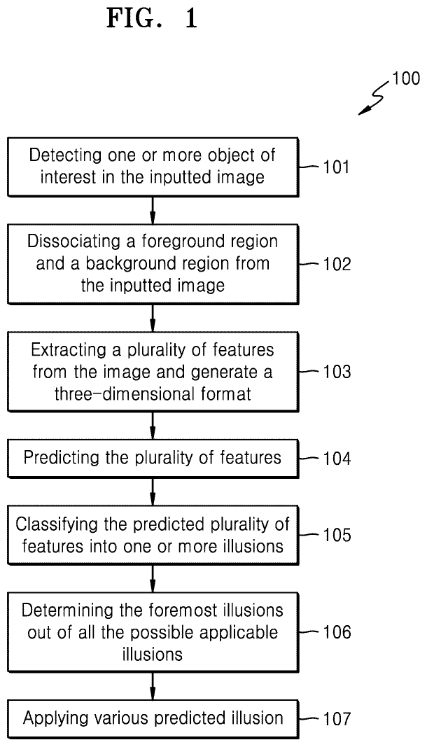

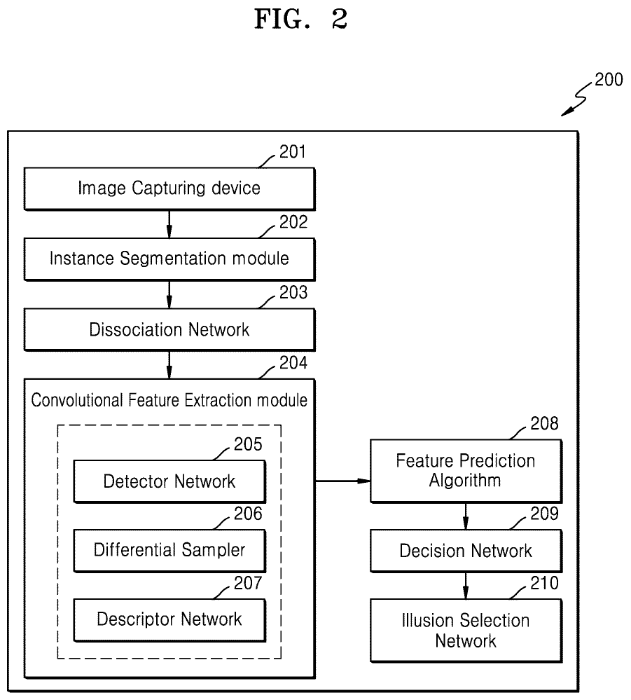

Referring to FIG. 1, a flowchart of an example method (100) for real time optical illusion photography is illustrated, wherein the method (100) comprises: receiving an input image from an image capturing device (e.g., 201 of FIG. 2) and detecting one or more objects of interest in the input image by an instance segmentation module (e.g., 202 of FIG. 2) in step (101), wherein in an embodiment, the image capturing device (201) may include a camera, a mobile, a tablet, or the like, but is not limited thereto.

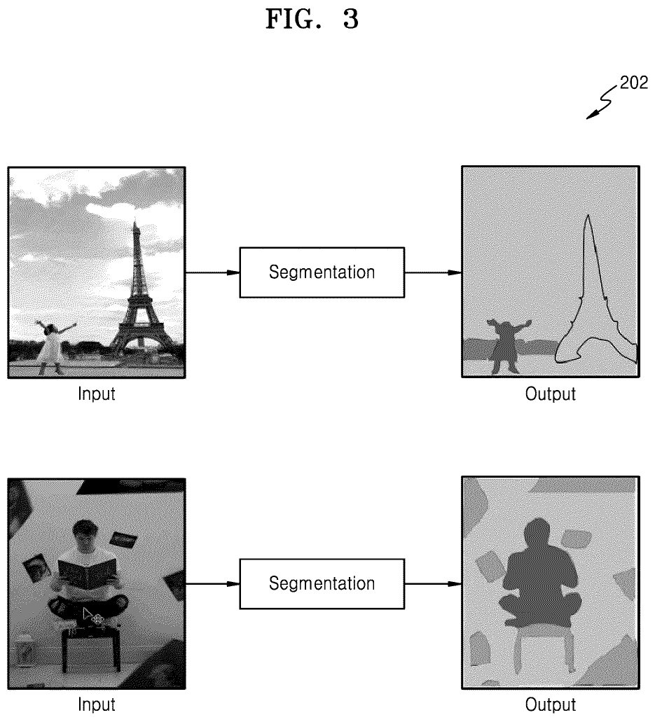

As it will be appreciated by those skilled in the art, image segmentation is the process of dividing a digital image into multiple image segments, also known as image regions or image objects (sets of pixels) as shown in FIG. 3. The goal of segmentation is to simplify and/or change the representation of an image into something more meaningful and easier to analyze. Image segmentation is commonly used to locate objects and boundaries (such as lines, curves) in images. Image segmentation assigns label to each pixel in an image so that pixels with the same label share certain characteristics.

In an embodiment of the disclosure, the method of detecting one or more objects of interest in the input image carried out by an instance segmentation module (202) is based on static objects which can change their shapes such as trees, water bodies, static objects which cannot change their shapes such as buildings, monuments, poles, and space, non-static objects which can change their shapes such as humans, animals and non-static objects which cannot change their shapes such as umbrella, vehicles.

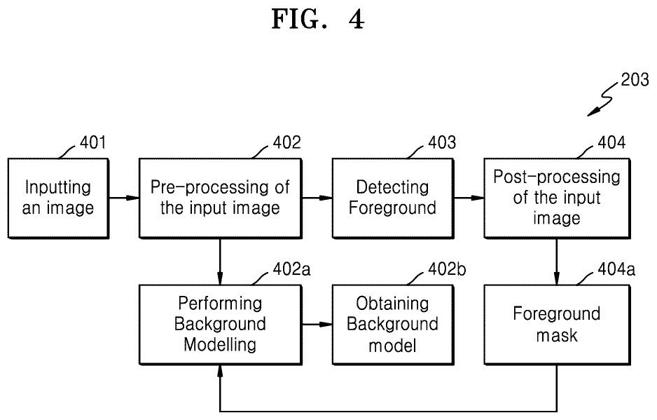

In step (102) of the method (100), a foreground region and a background region are dissociated from the input image using a dissociation network (e.g., 203 in FIG. 2). In an embodiment, the method of dissociating the foreground and the background region may include several steps as shown, for example, in FIG. 4 to follow. In step (402) of the method of dissociating, preprocessing of the input image is carried out which may further include adjustment of the geometry and intensity of the image. Further the method of dissociating the foreground and the background region may include background modeling (402a). In background modeling (402a), a recursive technique computationally efficient with minimal memory requirements may be used to maintain a single background model such as background subtraction.

As will be appreciated by those skilled in the art, background modeling methods may be categorized into parametric and nonparametric methods. One such method (pixel-based parametric method) may include a Gaussian model. The Gaussian distributions are used to model the history of active pixels and determine whether they belong to the background or foreground. The inactive pixels are classified as part of the background or foreground based on the classification of the previous active pixel. The recursive technique (approximate median filtering) may be used for the background subtraction. The technique may include a recursive filter to estimate the median as follows

$${B}_{t + 1}^{c} = {B}_{t}^{c} + 1 if {I}_{t}^{c} > {B}_{t}^{c}$$

$${B}_{t + 1}^{c} = {B}_{t}^{c} - 1 if {I}_{t}^{c} < {B}_{t}^{c}$$

$${B}_{t + 1}^{c} = {B}_{t}^{c} if {I}_{t}^{c} = {B}_{t}^{c}$$

Here, I^{c}ₜ is used to denote the value of channel c of the pixel at location (x, y) at time t for the foreground mask and B^{c}ₜ is used to denote the value of channel c of the pixel at location (x, y) at time t for the background model.

In an embodiment of the disclosure, the method of dissociating the foreground and background region may further include detection of the foreground region in step (403), which may be explained such as, the pixels in the foreground that cannot be explained adequately by the background model are assumed to be from a foreground object and forms the main distinction that determines the background model is statistical in nature. Various methods that provide variance measurement for each pixel of the image may be preferred. Whenever a new pixel appears, algorithms that model pixels as probability density functions for e.g., Running Gaussian Average (RGA), Gaussian Mixture Model (GMM), GMM with adaptive number of Gaussians (AGMM), and median classify the pixel as coming from the foreground whenever p(I^{c}ₜ|B^{c}ₜ)<T^{c}=η^{Ψc} for any channel c. The threshold T^{c} may be set proportional to the estimated variation, Ψ^{c}, to ensure a pixel is classified as being from the foreground only, when the pixel is outside the normally observed level of variance.

Furthermore, dissociating the foreground and the background region from the input image may comprise post processing at step (404) which may further include (i) Noise removal—the foreground mask (404a) usually contains numerous small “noise” blobs because of camera noise and the constraints of the background model. Applying a noise filtering method to the foreground mask (404a) may help to get rid of the incorrect blobs present in the foreground mask. Since the incorrect blobs may sometime obstruct later post-processing steps, therefore it may be preferable to remove the incorrect blobs as soon as possible. (ii) Blob processing—to recognize object-level blobs, the connected-component labelling may generally always be carried out. The blobs found in the foreground mask may be improved by morphological closing and area thresholding. Area thresholding may be used to remove blobs that are too small to be of interest while morphological closing may be used to fill internal holes and small gaps. In an embodiment, several post-processing techniques may be utilized to enhance the foreground masks produced by the foreground detection.

In step (103) of the method (100), a plurality of features are extracted from the foreground and the background region of the image in three-dimensional format by a convolutional feature extraction module (e.g., 204 in FIG. 2) and further a three-dimensional feature map is generated using a detector network (e.g., 205 in FIG. 2), a differential sampler (e.g., 206 in FIG. 2) and a descriptor network (e.g., 207 in FIG. 2) of the convolutional feature extraction module (204).

In step (104) of the method (100), the plurality of features are predicted from the feature map of the image using a feature prediction algorithm (e.g., 208 in FIG. 2) and further the predicted plurality of features are classified into one or more illusions, applicable on the input image with the help of a decision network (e.g., 209 in FIG. 2) based on prediction table.

In step (105) of the method (100), the predicted plurality of features are classified into one or more illusions, applicable on the input image with the help of a decision network (209) based on prediction table. In step (106) of the method (100), at least one foremost illusion is determined, out of all the possible applicable illusions using an illusion selection network (e.g., 210 in FIG. 2). Furthermore, in step (107) of the method (100), real time illusion effects are applied on the input image based on the obtained foremost illusion.

Referring to FIG. 2, a functional block diagram (200) of the real time optical illusion photography system according to various embodiments is illustrated. The real time optical illusion photography system may include an image capturing device (e.g., including various image capturing circuitry including a camera, a smartphone, a tablet, etc.) (201), an instance segmentation module (202), a dissociation network with an encoder-decoder architecture (203), a convolutional feature extraction module (204) with a detector network (205), a differential sampler (206), a descriptor network (207). Further, the system may include a feature prediction algorithm (208), a decision network (209) and an illusion selection network (210). Each of the modules and networks may include various circuitry and/or executable program instructions.

The image capturing device (201) may capture an input image to create illusions with the help of individual objects present in the image. In an embodiment, the image capturing device may be a camera or a mobile, or a tablet, etc. The instance segmentation module (202) of the system (200) may be configured to detect one or more objects of interest in the input image. The dissociation network with an encoder-decoder architecture (203) may be configured to dissociate the foreground region and the background region from the input image.

The convolutional feature extraction module (204) of the system (200) extracts the plurality of features from the foreground and the background region of the image in three-dimensional format. The detector network (205), the differential sampler (206) and the descriptor network (207) of the convolutional feature extraction module (204) generates the three-dimensional feature map. The feature prediction algorithm (208) predicts the plurality of features from the feature map of the image. The decision network (209) classifies the predicted plurality of features into one or more illusions, applicable on the input image based on prediction table and the illusion selection network (210) determines at least one foremost illusion, out of all the possible applicable illusions, wherein real time illusion effects are applied on the input image based on the obtained foremost illusion.

In an embodiment, the instance segmentation module (202) of the system (200) may detect one or more objects of interest in the input image based on static objects which can change their shapes, static objects which cannot change their shapes, non-static objects which can change their shapes and non-static objects which cannot change their shapes. In an embodiment, the feature prediction algorithm (208) predicts the plurality of features in the form of a Boolean array and each value of the Boolean array represents a particular feature of the image. In an embodiment, the decision network (209) of the system (200) uses a decision tree comprising a decision node and a leaf node for the classification of one or more illusions.

In an embodiment, the illusion selection network (210) of the system (200) determines the foremost illusion based on a multi-layer perceptron network. Further, the illusion selection network (210) of the system (200) predicts the score of each of the predicted illusion using an illusion classification algorithm on a scale of 0 to 100 and the scores predicted are used to determine at least one foremost possible illusion.

In an embodiment, the illusion selection network (210) of the system (200) may comprise a concatenation layer to combine the information from the multi-layer perceptron network and the feature extractor. As a result, an output image with enhanced illusion effects may be obtained.

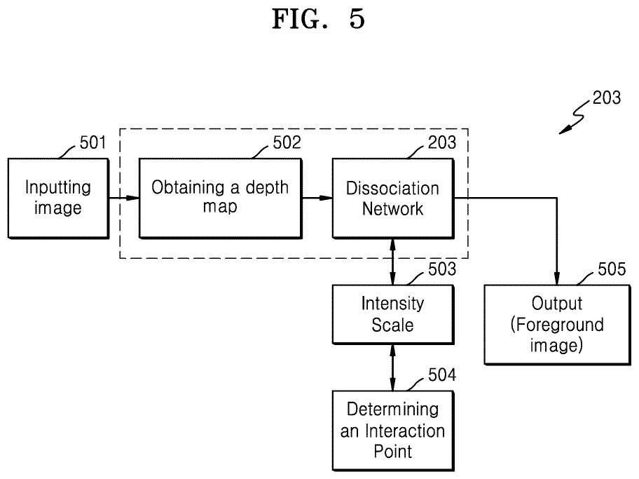

Referring to FIG. 5, a flowchart of an example method of dissociating the foreground region and the background region from the input image according to various embodiments is illustrated. The method of dissociating the foreground region and the background region from the input image uses the dissociation network (203) which may comprise receiving the input image at step (501). In step (502), a depth map may be obtained from the input image using a depth estimation module of the dissociation network (203) for extracting the depth information and further determining an interaction point (504) based on the preset intensity scale (503), further the method includes regenerating the foreground region by discarding the background region of the input image based on the interaction point (504).

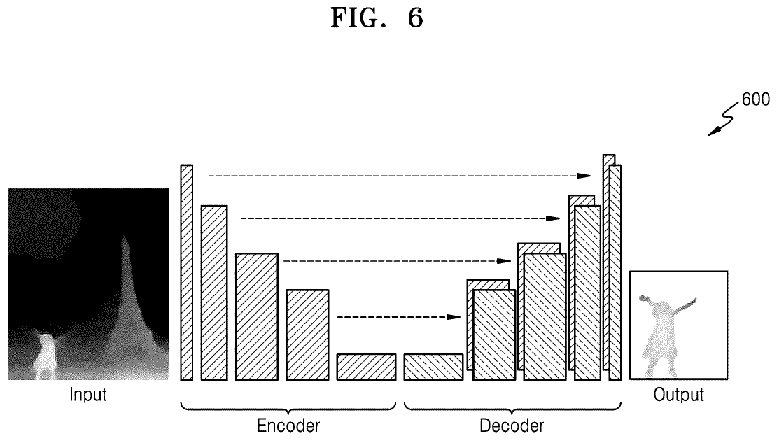

In an embodiment, the dissociation network with an encoder-decoder architecture (203) helps to calculate the interaction point and further the interaction point may be used to dissociate the foreground with the background region as shown in FIG. 6. In an embodiment of the disclosure, single straightforward encoder-decoder architecture 600 with skip connections may be used for dissociation. The decoder may be include basic blocks of convolutional layers applied on the concatenation of the 2× bilinear up sampling of the previous block, with the block in the encoder with the same spatial size after up sampling. The feature vector may then fed to a successive series of up-sampling layers, to construct the final depth map at half the input resolution. The up-sampling layers and their associated skip-connections forms the decoder. The performance of depth estimation, module of the dissociation network (203) as well as training speed, may be significantly impacted by a loss function. For training the dissociation network, the loss L between y and y\hat{ } as the weighted sum of three loss functions, wherein y is the ground truth depth map and y\hat{ } is the prediction of the depth regression network:

$$L ( y , y \hat{} ) = λ {L}_{depth} ( y , y \hat{} ) + {L}_{g r a d} ( y , y \hat{} ) + {L}_{S S I M} ( y , y \hat{} ) . \qquad ( 1 )$$

The first loss term L_{depth} is the pointwise L1 loss defined on the depth values:

$${L}_{depth} ( y , y \hat{} ) = ( 1 / n ) * \sum \vert {y}_{p} - y {\hat{}}_{p} \vert . \qquad ( 2 )$$

The second loss term L_{grad} is the L1 loss defined over the image gradient g of the depth image:

$${L}_{g r a d} ( y , y \hat{} ) = ( 1 / n ) * \sum \vert {g}_{x} ( {y}_{p} , y {\hat{}}_{p} ) \vert + \vert {g}_{y} ( {y}_{p} , y {\hat{}}_{p} ) \vert . \qquad ( 3 )$$

where gₓ and g_{y}, respectively, compute the differences in the x and y components for the depth image gradients of y and y\hat{ }.

Loss for Structural Similarity LSSIM may be as follows:

$${L}_{SSIM} ( y , y \hat{} ) = 1 - SSIM ( y , y \hat{} ) / 2. \qquad ( 4 )$$

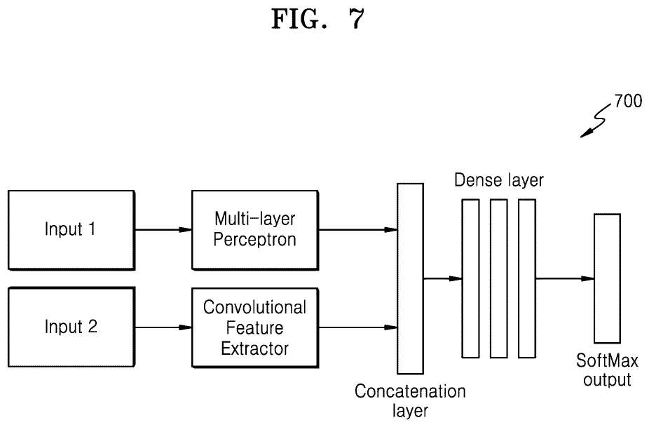

In an embodiment, a 2D convolution with kernel size of 3×3 may be used for extracting features from the image. More particularly, the convolution involving two-dimensional signals with kernel size of 3×3 may be used for extracting features from the image. Thirty-two (32) number of filters may be used at the first layer of the convolution and doubled after each max pooling layer. After feature extraction, a flatten operation may be applied to prepare the feature vectors for concatenation. Furthermore, the information from the multi-layer perceptron and feature extractor hidden layers may be combined using a concatenation layer. To classify the concatenated information tensor, dense layers with drop-out and Rectified Linear Activation Function (ReLU) may be used. The dense or fully connected part of the dissociation network may be include 3 layers with 256, 128 and 128 neurons respectively. In an embodiment, a neural network model uses the SoftMax function as the activation function in the output layer may predict a score on a scale of 100 as shown in 700 of FIG. 7.

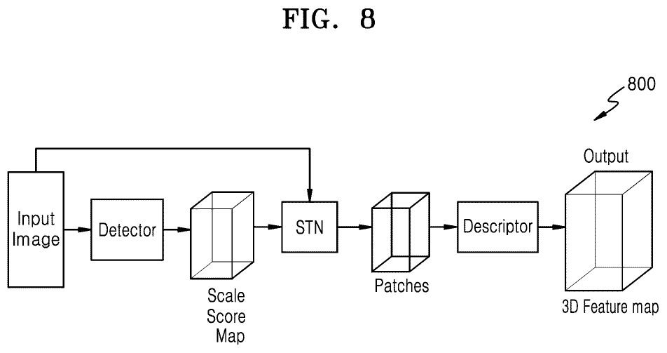

Referring now to FIG. 8, a block diagram (800) an example configuration of the foreground and the background region interpretation, according to various embodiments, is illustrated. The interpretation of the foreground and the background region helps to elucidate important features from the input image. The dissociated foreground and the background region may act as input for a detector network (205). In an embodiment, the detector network (205), a fully convolutional network generates a scale-space score map such as rich feature map along with dense orientation, which may be used to extract key point locations as well as their attributes, such as scale and orientation estimates from an image. Image patches around the chosen key points are cropped with a differentiable sampler (STN) (206) and further fed to the descriptor network (207) for generating a descriptor Dᵢ^{k} in a form of 3 dimensional feature map of size (w, h, i, c).

In an embodiment, to detect scale-invariant key points denoted by (S), a novel approach may be used, in which scale-space detection relies on the feature map. In an embodiment, to be acquainted with orientations on the feature map, a single 5→5 convolution may be used, which further produces two values for each pixel. The orientation's sine and cosine may be considered, for further use to compute a dense orientation map with the help of an arctan function.

In an embodiment, the detector network (205) a dense, multi-scale, fully convolutional network may be configured to return key point locations, scales, and orientations. The descriptor network (207) may generate a descriptor D in the form of a 3D feature map from patches cropped around the key points produced by the detector. The descriptor comprises of three 3×3 convolutional filters with strides of 2 and 64, 128, and 256 channels, respectively. Each one of the convolutional filters may be followed by batch normalization and ReLU activation. Following the convolutional layers, a fully connected 512-channel layer exists, followed by batch normalization, ReLU, and a final fully connected layer to reduce the dimensionality to M=256.

In an embodiment, to increase the saliency of the key points, differentiable sampling in the form of non-maximum suppression using a SoftMax operator over 15×15 convolutional windows may be performed, resulting in N sharper score maps, as the non-maximum suppression results may be scale-dependent, each score map may further be resized to the original image size before merging all of the score maps into a final scale-space score map.

In an embodiment, the 3D feature map may be obtained as an input for the decision network (209), further the feature vector that may be encoded with the help of encoder may be obtained. Furthermore, the plurality of features are predicted in the form of a Boolean array with the help of a feature prediction algorithm (208) and each value of the Boolean array represents output class, in other words, each value of the Boolean array represents particular feature of the image.

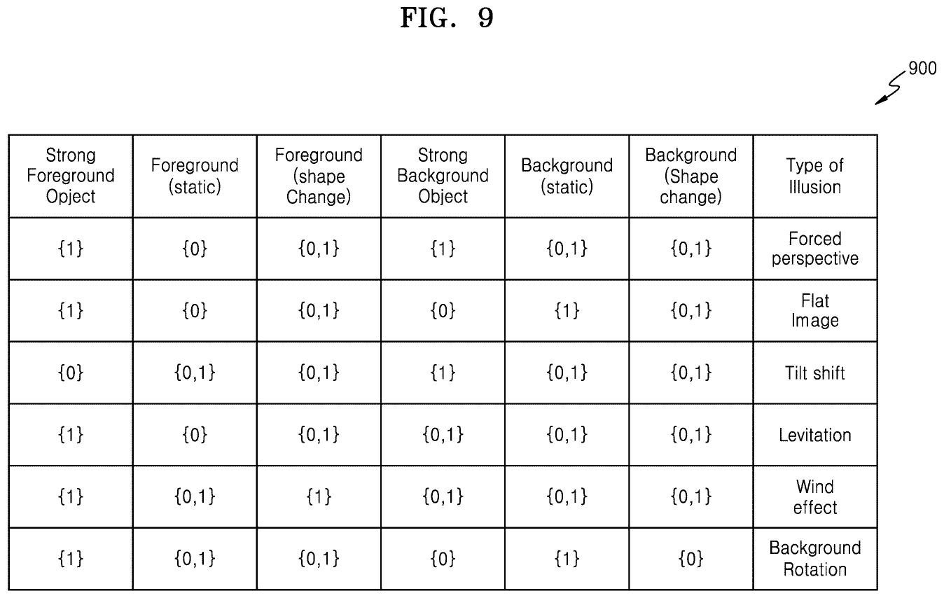

In an embodiment, a decision tree, is a classification model trained on a dataset to predict various output classes based on the feature vector. In a decision tree, each internal node (non-leaf node) denotes a test on an attribute, each branch represents an outcome of the test, and each leaf node (or terminal node) holds a class label. The topmost node in a tree is the root node. The input may be Boolean array predicted by our feature prediction algorithm and the output may be the multiple illusion. The output array 900 of the decision network (209) as shown in FIG. 9 which may help to decide the numerous illusion that can be applied on the input image.

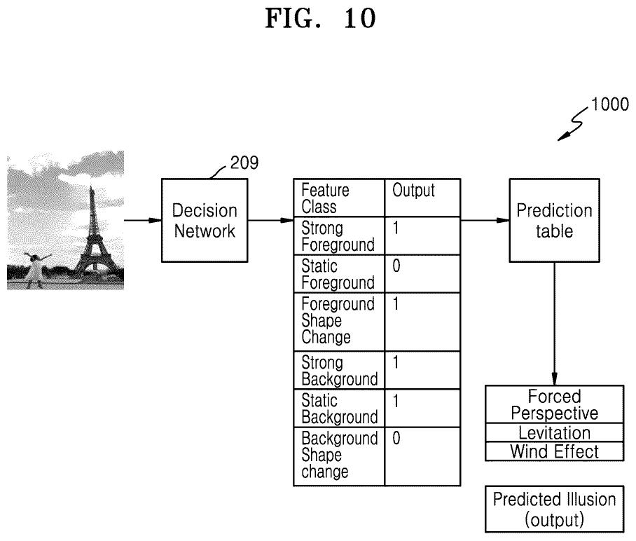

In an embodiment, a first example method (1000) for real time optical illusion photography as shown in FIG. 10, according to various embodiments, may be illustrated. An image may be received as an input, which may further be classified into the plurality of features using decision network (209) and further the predicted plurality of features may be classified into one or more illusions, applicable on the input image with the help of a decision network (209) based on prediction table.

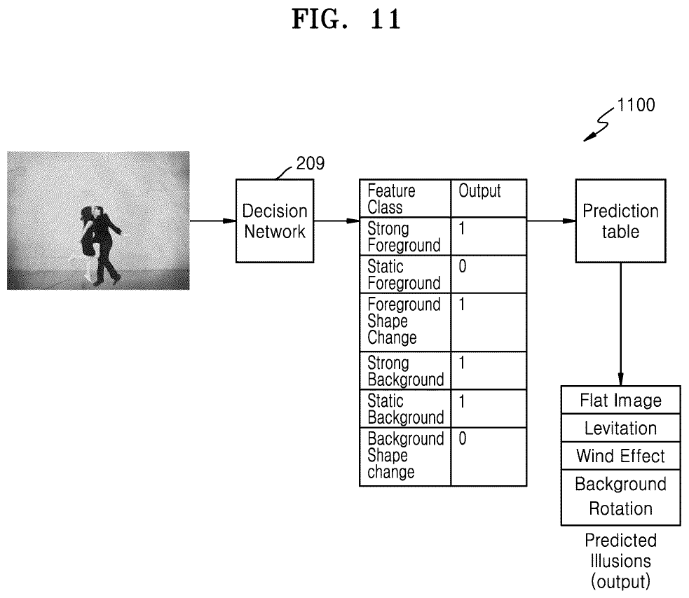

In an embodiment, a second example method (1100) for real time optical illusion photography as shown in FIG. 11, according to various embodiments, may be illustrated. An input image may be received and may further be classified into the plurality of features using decision network (209) and further the predicted plurality of features may be classified into one or more illusions, applicable on the input image with the help of a decision network (209) based on prediction table.

In an embodiment, an input in the form of numerical and multi-categorical data comprising of the actual size of foreground object, complexity of background, and the predicted illusions may be received by the illusion selection network (210), wherein the actual size of foreground object may be calculated by finding out the pixel value based on the segmentation module (202) and the background complexity may be calculated by finding pixel ratio of foreground with background based on segmentation module (202).

Furthermore, the score of each of the predicted illusion may be predicted by an illusion selection network (210) using an illusion classification algorithm on a scale of 0 to 100 and the scores predicted may be used to determine at least one foremost possible illusion. The scores predicted by the illusion selection network (210) may be normalized to 1 and may further be used to find the best illusion. Further, a threshold value such as 30% may be set to reject an illusion effect such that any illusion effect applied on the input image having threshold value less than 30% may not provide a prominent output.

Furthermore, the foremost illusion is determined by the illusion selection network (210) on the basis of a multi-layer perceptron network. The relation between the numerical data such as actual size of foreground object, pixel ratio of foreground to background and the categorical data obtained from the illusion classification algorithm on the basis of multi-layer perceptron network wherein the multi-layer perceptron network is an Artificial Neural Network (ANN).

By the way of an example the predicted illusion such as forced perspective, levitation, and wind effect with scores 90, 65, and 30 respectively are considered for creating enhanced illusion effect associated with an image. The predicted scores are normalized to 1, such as normalized scores as 0.49, 0.35, and 0.16 respectively. The illusion effect associated with normalized score less than 0.30 (wind effect) is rejected based on the set threshold value and to predict the rating of output classes, a multi-input model transfer learning with SoftMax output may be used.

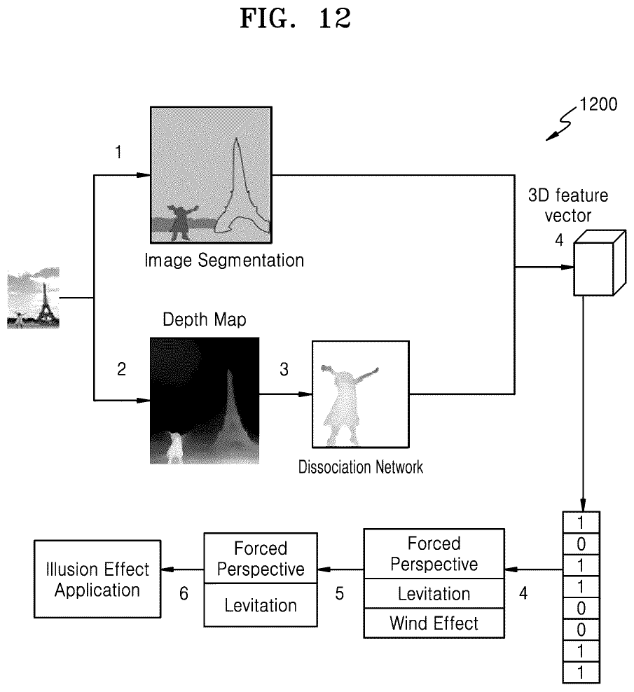

Referring now to FIG. 12, a third example method (1200) for real time optical illusion photography according to various embodiments of the disclosure is illustrated. The input image may be received for creating illusion effects. In step 1, one or more object of interest may be depicted or segmented from the input image. In step 2, the depth map may be obtained from the input image for extracting the depth information and determining an interaction point. the foreground region and the background region may be dissociated from the input image using a dissociation network (203). In step 3, the plurality of features may be extracted from the foreground and the background region of the image in three-dimensional format by convolutional feature extraction module (204) and further the three-dimensional feature map may be generated. The plurality of features are predicted in the form of Boolean array in the step 4, and each value of the Boolean array represents a particular feature of the image. In step 5, the predicted plurality of features are classified into one or more illusions, applicable on the input image with the help of decision network (209) based on prediction table such as forced perspective, levitation, and wind effect.

In step 6, at least one foremost illusion, may be determined out of all the possible applicable illusions using an illusion selection network (210) such as forced perspective and levitation. Real time illusion effects may be applied on the input image based on the obtained foremost illusion.

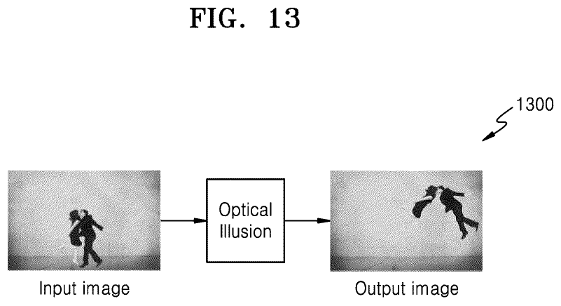

In an embodiment, an image may be received as an input. And further multiple illusion effects such as levitation and wind effect can be applied with the help of optical illusion engine on a single input image to achieve a candid pose 1300 as shown in FIG. 13. The candid nature of a photograph is unrelated to the subject's knowledge of or consent to the fact that photographs are being taken.

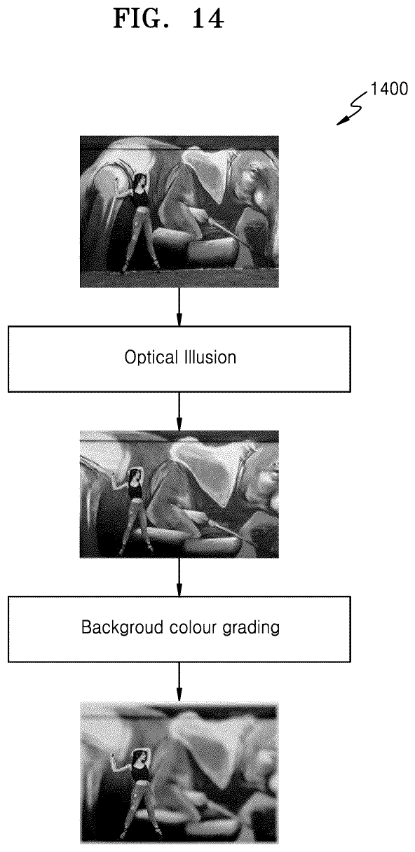

In an embodiment, an input image may be received to obtain cinematic styling 1400 as shown in FIG. 14. Further the image may be normalized, and the contrast and saturation of the input image may be fixed. Furthermore, the image color correction is performed by setting contrast, exposure, and white balance. Once the color correction is completed, lastly, in order to create a cinematic styling or look image is color graded by setting the adjustments to different color levels. In other words, color grading is to enhance or alter the color of a motion picture, video image, or still image and involves a process to fine tune the colors and create a cinematic look.

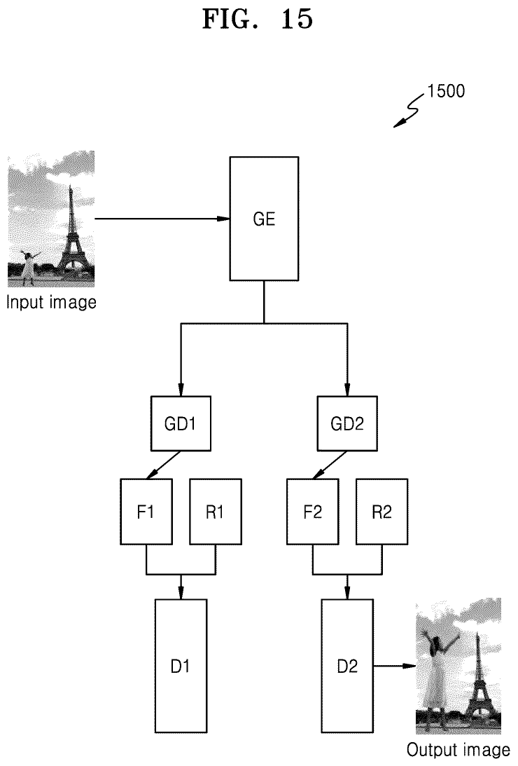

In an embodiment, the forced perspective may include a technique which employs optical illusion to make an object appear farther away, closer, larger, or smaller than it actually is. The forced perspective technique manipulates human vision perception using scaled objects and finding the correlation between them. The pipeline for achieving forced perspective comprises of foreground scaling and foreground translation. In foreground scaling, the object may be foregrounded with respect to the background object. For scaling technique, a Generative Adversarial Network (GAN) based architecture 1500 may be followed as shown in FIG. 15. The generative adversarial network (GAN) comprises of two parts: generator (Gi) and discriminator (Di). The generator (Gi) further comprises of two components: a shared encoder network (GE) and two decoder networks (GD1 and GD2), and Gi is defined as (GE+GDi). The encoder is a deep-CNN based architecture, which may take the input images with resolution of 64×64 pixels and outputs a vector. The encoder further maps the input images to a latent space to produce an encoded vector, which acts as an input to each of the two decoder networks (D1 & D2).

The decoder output Fi (F1 & F2) may be used along with a separate batch of real images Ri (R1 & R2) with distinct scaling of foreground. The decoder module further generates images at a specific scaling of foreground, given any image with a strong background. The input image passes through encoder (GE) & decoder (GD1 & GD2) architecture and produces fake images (F1 & F2) which much correspond to the real distinct images of the input image, wherein input image is the image passing as an input to the training model and real image is the corresponding image to the input images with distinct scaling of the foreground object. The network may further include separate discriminator networks Di (D1 & D2), which recognizes fake images (Fi) generated by GDi from original images (Ri) along with classifying input images into separate categories. More particularly, the discriminator module (Di) is used to discriminate between the output of our generator module and the real images with distinct scaling of foreground.

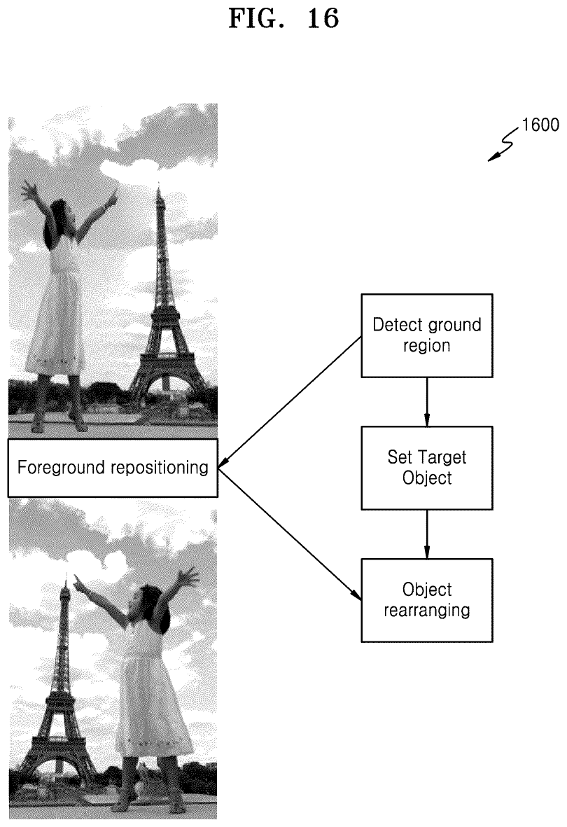

In an embodiment, the repositioning of the foreground region may include repositioning the object to a new position such that the foreground object correlates with the background object 1600 as shown in FIG. 16. The input for repositioning the foreground region may be the output of foreground scaling with respect to background. For repositioning, the input image may be divided into two regions: a ground region and the other region such as buildings or the sky. The objects which may be attached to the ground may only be considered for repositioning. The process of repositioning may include steps such as detecting ground region which comprises specifying a boundary of a ground region with a polygonal line to estimate depth of the scene, setting target object which comprise setting bounding boxes around objects to extract target objects, and object rearranging which comprises rearranging the position of objects with automatic adjustment of object based on scene perspective.

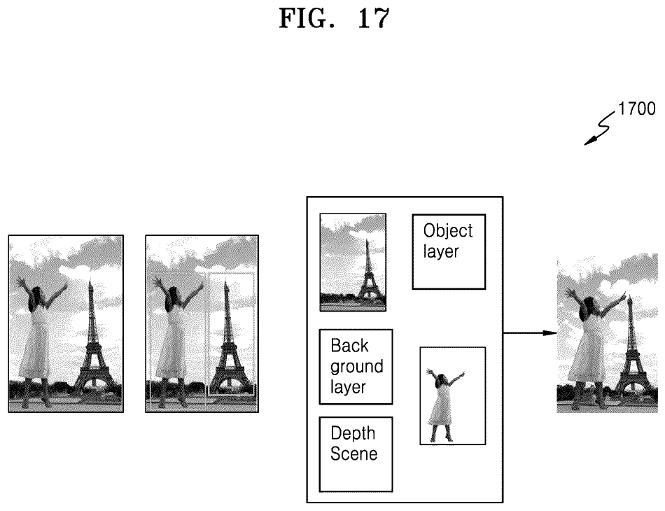

For repositioning of the foreground region following steps may be followed such as an image may be segmented into nearly uniform regions called super pixels. Further the image may be converted into a layer structure that includes multiple object layers and a background layer using a boundary line and a bounding box specified by the user. Further, the object layers may be generated based on regions of human interest called salient regions which are computed from bounding boxes and super pixels. Furthermore, the region behind the object may be filled automatically by an image patch-based completion method constrained with the polygonal line. Finally, the system estimates the depth of the scene from the ground region to decide the size and order of overlapping of objects according to the scene 1700 as shown in FIG. 17.

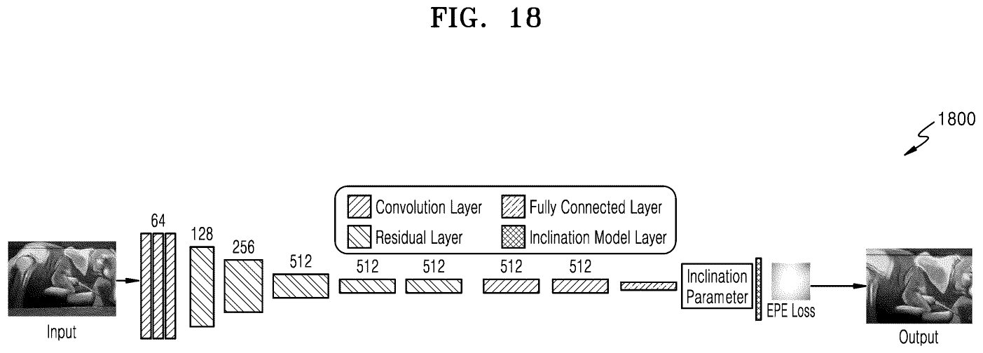

In an embodiment, a method for creating real time illusion effect on a flat image is disclosed. The segregated foreground and background region, and the raw image may be received as an input. The input image may be very much like an outdoor image in which objects are placed perpendicular to the flat ground. The user may specify a ground region with a polygonal line, objects with bounding boxes and shadow regions with rough scribbles. Further, the method or creating real time illusion effect on a flat image may include tilted background regeneration. The network architecture for creating real time illusion effect on a flat image 1800 is shown in FIG. 18.

In an embodiment, the tilted background regeneration may be obtained by implementing following steps such as the regenerated background may be inclined at some angle with respect to the foreground object to create a sense of zero depth, the designed network predicts model parameters ρ, β and use them to generate the flow F=M^{β} in the network. Three convolution layers followed by five residual blocks may exists to downsize input image and extract features. Each residual contains two convolution layers with a shortcut connection from input to output to achieve lower loss. Furthermore, the method may include down-sampling in spatial resolution using convolution layers with a stride of 2 and 3×3 kernels. Each convolution layer is followed by batch normalization layers and ReLU function to significantly improve training. Further, two conv layers may be added after residual blocks to downsize the features, followed by a fully connected layer converting 3D feature map to ID vector ρ^{β}. The corresponding model M^{β} analytically generating the bending angle flow with the bending parameter ρ^{β}. Further, the network is optimized with the pixel-wise flow error between the generated flow and the ground truth.

Further, the method for creating real time illusion effect on a flat image may include foreground-background stitching. In foreground-background stitching, the foreground object may be rearranged/aligned with the tilted background at the same position as it was in input image. Further, the method or creating real time illusion effect on a flat image may include shadow removal. Lastly, the final image is presented as an output image.

In an embodiment, a method for imitating a tilt shift is disclosed. The tilt shift may include steps such as receiving an input image, obtaining perspective wrapping using homography, adding shallow depts of field and obtaining imitation of miniature effect.

In an embodiment, a method for creating levitation photography is disclosed. The method may include receiving an input image, detection of the ground plane, removal of the support or translation of the object, inpainting and lastly obtaining an output image with levitation effect. In an embodiment, ground detection may use a mask R-CNN based model for detecting planes. In mask R-CNN based model each planar region may be treated as an object instance and further, the mask R-CNN detect object instances and estimate their segmentation masks. Further, the model infers plane parameters, which includes the normal and the offset information. The parameters which may be required for ground plane detection are such as the depth map, surface normal and plane offset. The method may be implemented by predicting a normal per planar instance and estimating depth map for an entire image using a simple algebraic formula to calculate the plane offset.

In an embodiment, the method for creating wind effect is disclosed. The wind effect can be achieved by implementing steps such as receiving an image as an input, selecting entities from the input image, feeding all the selected entities to random function, wherein random function randomly calculates the deviation angle/rotating angles for the objects which are not attached to any other object or whose boundary if free & not shared with other entity. The method further includes developing a machine learning model such as a GAN based model may be developed to apply wind effect on the objects, wherein the objects which are free or not attached with any other objects are just rotated at their in-place, and the objects which are attached with some other objects are fed into deviation network which further re-shapes the objects by creating a deviation like effect on them. Furthermore, the objects are rotated or translated, and a void may be created in background of the image, wherein the space pre-occupied by object may be filled by in-painting and a GAN based model may be developed to in-paint the void spaces thus created.

In an embodiment, the method for creating illusion effect by background rotation is disclosed. The method may be achieved by implementing steps such as receiving an image as an input, separating the foreground region with the background region of the input image, rotating the background region by 90 degrees such as the background may be rotated in the clockwise direction or in the anti-clockwise rotation. As appreciated by those skilled in the art, if the line of intersection of two planes in an image lie at the right side of the image then the background is rotated in clockwise direction, if the line of intersection of two planes in an image lie at the left side of the image then the background is rotated in anti-clockwise direction, and if the line of intersection of two planes in an image lie at both sides of the image then the background is rotated in a direction with respect to the plane which leads to greater depth in the input image.

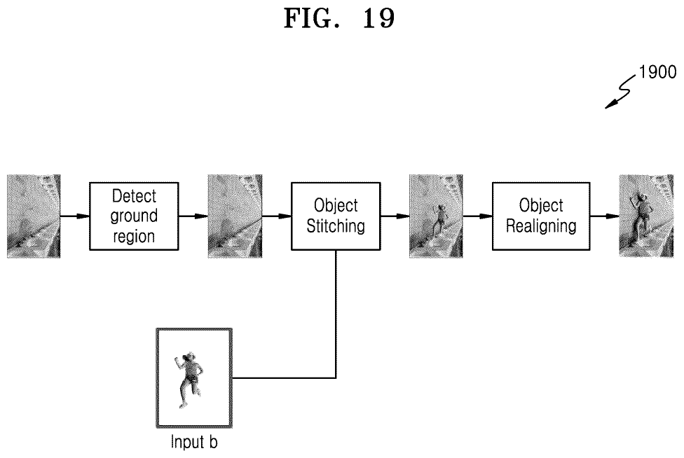

Further, the method may include alignment of the foreground region or the subject to the intersection of two planes. In an embodiment, the process of subject alignment may include detecting ground region, object stitching, and object realigning 1900 as shown in FIG. 19.

The disclosure provides a system and method for real time optical illusion photography. Additionally, the method also provides volume and expressiveness to the image. Further, the method disclosed in the present disclosure helps in achieving lightening effect and spotlight. Furthermore, the disclosed method helps in applying multiple illusion effects on a single input image to achieve a candid pose.

At least one of the plurality of modules may be implemented through an Artificial Intelligence (AI) model. A function associated with AI may be performed through the non-volatile memory, the volatile memory, and the processor. The processor may include one or a plurality of processors. At this time, one or a plurality of processors may be a general-purpose processor, such as a Central Processing Unit (CPU), an Application Processor (AP), or the like, a graphics-only processing unit such as a Graphics Processing Unit (GPU), a Visual Processing Unit (VPU), and/or an AI-dedicated processor such as a Neural Processing Unit (NPU). The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The one or a plurality of processors control the processing of the input data in accordance with a predefined operating rule or Artificial Intelligence (AI) model stored in the non-volatile memory and the volatile memory. The predefined operating rule or artificial intelligence model is provided through training or learning. Here, being provided through learning may refer, for example, to, by applying a learning algorithm to a plurality of learning data, a predefined operating rule or AI model of a desired characteristic being made. The learning may be performed in a device itself in which AI according to an embodiment is performed, and/o may be implemented through a separate server/system.

The AI model may include a plurality of neural network layers. Each layer has a plurality of weight values and performs a layer operation through calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-networks. The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Various embodiments may be implemented or supported by one or more computer programs, which may be formed from computer-readable program code and embodied in a computer-readable medium. Herein, application and program refer to one or more computer programs, software components, instruction sets, procedures, functions, objects, class, instance, and related data, suitable for implementation in computer-readable program code. Computer-readable program code may include various types of computer code including source code, object code, and executable code. Computer-readable medium may refer to read only memory (ROM), RAM, hard disk drive (HDD), compact disc (CD), digital video disc (DVD), magnetic disk, optical disk, programmable logic device (PLD) or various types of memory, which may include various types of media that can be accessed by a computer.

In addition, the device-readable storage medium may be provided in the form of a non-transitory storage medium. The non-transitory storage medium is a tangible device and may exclude wired, wireless, optical, or other communication links that transmit temporary electrical or other signals. On the other hand, this non-transitory storage medium does not distinguish between a case in which data is semi-permanently stored in a storage medium and a case in which data is temporarily stored. For example, the non-transitory storage medium may include a buffer in which data is temporarily stored. Computer-readable media can be any available media that can be accessed by a computer and can include both volatile and nonvolatile media, removable and non-removable media. Computer-readable media includes media in which data can be permanently stored and media in which data can be stored and later overwritten, such as a rewritable optical disk or a removable memory device.

According to an embodiment, the method may be provided as included in a computer program product. Computer program products may be traded between sellers and buyers as commodities. The computer program product is distributed in the form of a machine-readable storage medium (e.g., CD-ROM), or is distributed between two user devices (e.g., smart phones) directly or through online (e.g., downloaded or uploaded) via an application store. In the case of online distribution, at least a portion of the computer program product (e.g., a downloadable app) may be temporarily stored or created in a device-readable storage medium, such as a memory of a manufacturer's server, a server of an application store, or a relay server.

According to an example embodiment of the disclosure, there is provided a method for real time optical illusion photography. The method of detecting one or more objects of interest in the input image by an instance segmentation module is based on static objects which can change their shapes, static objects which cannot change their shapes, non-static objects which can change their shapes and non-static objects which cannot change their shapes.

The method of dissociating a foreground region and a background region from the input image using a dissociation network may include obtaining a depth map from the input image using a depth estimation module for extracting the depth information and determining an interaction point and regenerating the foreground region by discarding the background region of the input image based on the interaction point.

The three-dimensional feature map is used to extract key point locations as well as their attributes from the input image.

The plurality of features are predicted in the form of a Boolean array with the help of the feature prediction algorithm and each value of the Boolean array represents a particular feature of the image.

The decision network uses a decision tree comprising a decision node and a leaf node for the classification of one or more illusions.

The illusion selection network predicts a score of each of the predicted illusion using an illusion classification algorithm on a scale of 0 to 100 and the scores predicted are used to determine at least one foremost possible illusion.

The illusion selection network may include a concatenation layer to combine the information from the multi-layer perceptron network and the feature extractor.

According to an example embodiment of the disclosure, there is provided a system for real time optical illusion photography. The instance segmentation module detects one or more objects of interest in the input image based on static objects which can change their shapes, static objects which cannot change their shapes, non-static objects which can change their shapes and non-static objects which cannot change their shapes.

The plurality of features are predicted in a form of a Boolean array with the help of the feature prediction algorithm and each value of the Boolean array represents a particular feature of the image.

The decision network uses a decision tree comprising a decision node and a leaf node for the classification of one or more illusions.

The illusion selection network predicts a score of each of the predicted illusion using an illusion classification algorithm on a scale of 0 to 100 and the scores predicted are used to determine at least one foremost possible illusion.

The illusion selection network comprises a concatenation layer to combine the information from the multi-layer perceptron network and the feature extractor.

To create optical illusion photography, the current art uses manual techniques. A combination of manual tools and challenging image editing software programs, like Photoshop, are used to re-edit the images. Since it requires prior knowledge to use the sophisticated image editing tools, there was not a lot of awareness on how to modify the images again. The current disclosure provides a software solution that enables the automatic creation of many forms of optical illusions in images without the use of manual tools or overly complicated photo-editing software.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for real time optical illusion photography, the method comprising:
receiving an input image;
detecting one or more objects of interest in the input image;
dissociating a foreground region and a background region from the input image;
extracting a plurality of features from the foreground and the background region of the image in three-dimensional format;
generating a three-dimensional feature map;
predicting the plurality of features from the feature map of the image;
classifying the predicted plurality of features into one or more illusions which are applicable on the input image based on prediction table;
determining at least one foremost illusion, out of all possible applicable illusions; and
applying real time illusion effects on the input image based on the determined foremost illusion.

2. The method of claim 1, wherein the detecting of the one or more objects of interest in the input image comprises:
detecting the one or more objects of interest in the input images based on static objects which can change their shapes, static objects which cannot change their shapes, non-static objects which can change their shapes and non-static objects which cannot change their shapes.

3. The method of claim 1, wherein the dissociating of the foreground region and the background region from the input image comprises:
obtaining a depth map from the input image depth information and determining an interaction point; and
regenerating the foreground region by discarding the background region of the input image based on the interaction point.

4. The method of claim 1, wherein the three-dimensional feature map is used to extract key point locations as well as their attributes from the input image.

5. The method of claim 1, wherein the plurality of features is predicted in a form of a Boolean array and each value of the Boolean array represents a particular feature of the image.

6. The method of claim 1, wherein the classifying of the predicted plurality of features into one or more illusions comprises:
classifying the predicted plurality of features into the one or more illusions which are applicable on the input image based on the prediction table, using a decision tree comprising a decision node and a leaf node for the classification of the one or more illusions.

7. The method of claim 1, wherein the determining of the at least one foremost illusion comprises:
predicting a score of each of illusion on a scale of 0 to 100,
wherein the predicted score is used to determine at least one foremost possible illusion.

8. The method of claim 1, wherein the determining of the at least one foremost illusion comprises:
determining the at least one foremost illusion, out of all possible applicable illusions using an illusion selection network,
wherein the illusion selections network comprises a concatenation layer configured to combine information from a multi-layer perceptron network and a feature extractor.

9. A system for real time optical illusion photography, the system comprising:
a memory; and
at least one processor, comprising processing circuitry, coupled to the memory, at least one processor, individually and/or collectively, configured to:
receive an input image;
detect one or more objects of interest in the input image;
dissociate a foreground region and a background region from the input image;
extract a plurality of features from the foreground and the background region of the image in three-dimensional format;
generate a three-dimensional feature map;
predict the plurality of features from the feature map of the image;
classify the predicted plurality of features into one or more illusions which are applicable on the input image based on prediction table;
determine at least one foremost illusion, out of all possible applicable illusions; and
apply real time illusion effects on the input image based on the determined foremost illusion.

10. The system of claim 9, wherein the at least one processor, individually and/or collectively, is configured to:
detect the one or more objects of interest in the input image based on static objects which can change their shapes, static objects which cannot change their shapes, non-static objects which can change their shapes and non-static objects which cannot change their shapes.

11. The system of claim 9, wherein the plurality of features is predicted in a form of a Boolean array and each value of the Boolean array represents a particular feature of the image.

12. The system of claim 9, wherein the at least one processor, individually and/or collectively, is configured to:
classify the predicted plurality of features into the one or more illusions which are applicable on the input image based on the prediction table, using a decision tree comprising a decision node and a leaf node for the classification of the one or more illusions.

13. The system of claim 9, wherein the at least one processor, individually and/or collectively, is configured to:
predict a score of each of illusion on a scale of 0 to 100,
wherein the predicted score is used to determine at least one foremost possible illusion.

14. The system of claim 9, wherein the at least one processor, individually and/or collectively, is configured to:
determine the at least one foremost illusion, out of all possible applicable illusions using an illusion selection network,
wherein the illusion selection network comprises a concatenation layer configured to combine information from a multi-layer perceptron network and a feature extractor.

15. A non-transitory computer-readable storage medium storing a program executable by a computer to execute the method of claim 1.
